(19) United States
(12) Patent Application Publication
(10) Pub. No.: US 2012/0321451 A1
(43) Pub. Date: Dec. 20, 2012

(54) Bearing Housing Cooling System

(75) Inventors: Xinwen Xiao, San Diego, CA (US); James C. Napier, San Diego, CA (US); Gao Yang, SanDiego, CA (US); Loc Quang Duong, San Diego, CA (US); Steven R. Falconer, Escondido, CA (US)

(73) Assignee: Hamilton Sundstrand Corporation, Windsor Locks, CT (US)

(21) Appl. No.: 13/164,092

(22) Filed: Jun. 20, 2011

(51) Int. Cl. F02C 7/12

(52) U.S. Cl. 415/180

(57) ABSTRACT

A cooling system for the rear bearing capsule of a turbine in a gas turbine engine supported by an exhaust cone attached to multiple exit guide vanes that extend radially from the exhaust cone to an exhaust housing, comprises: an inlet air flow path through each guide vane between a source of cool ambient air and the rear bearing capsule; and at least one discharge air flow path that receives air from the inlet air flow path through each guide vane and passes the air through the exhaust cone from the rear bearing capsule to a high velocity gas flow path in the exhaust housing.

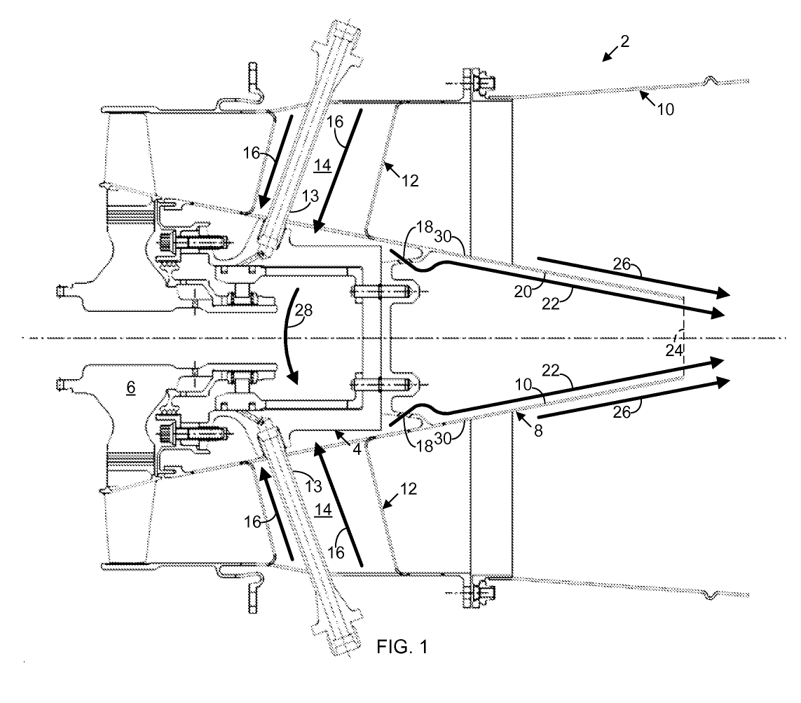

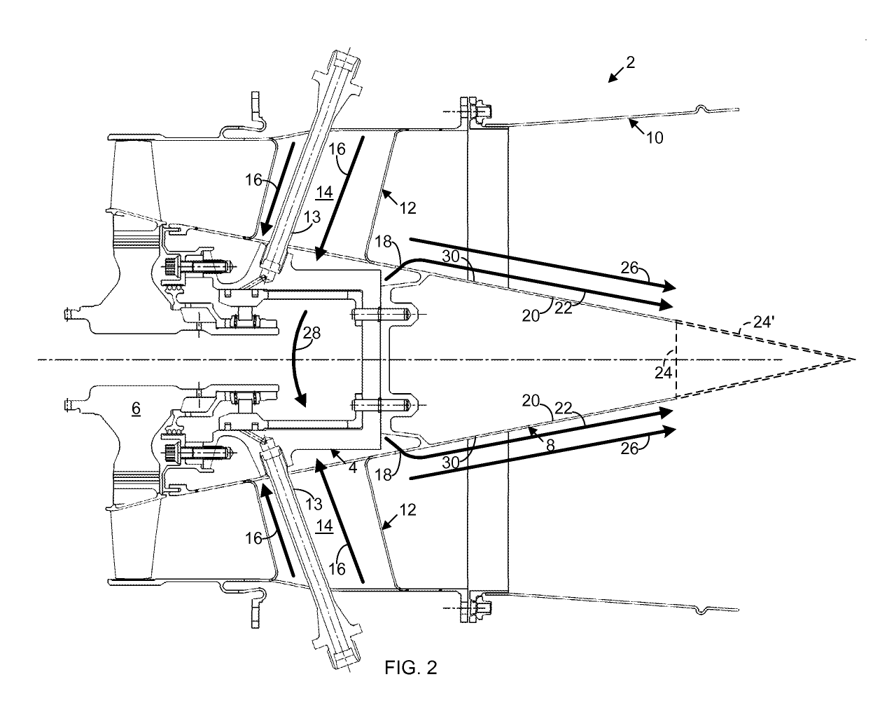

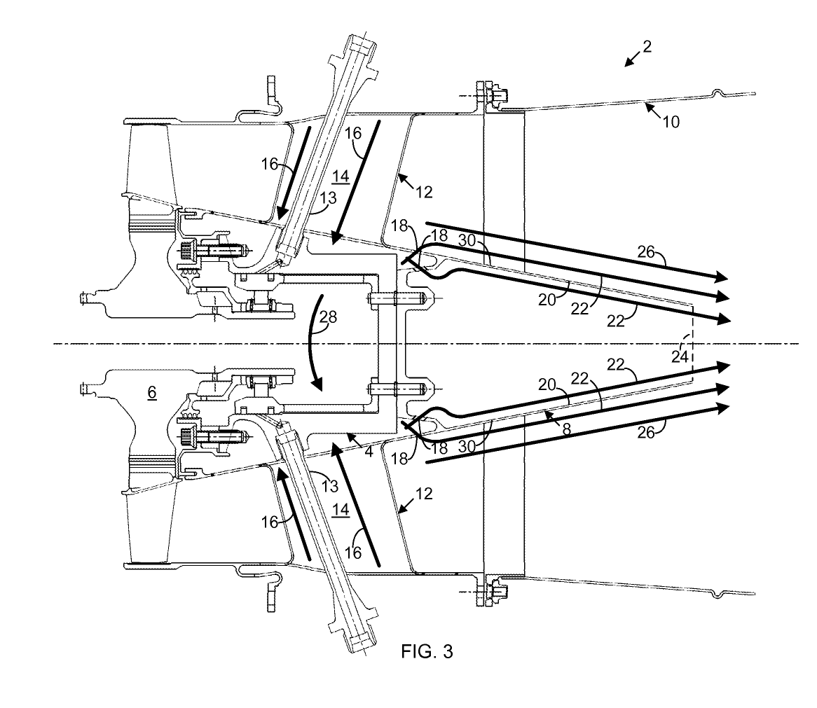

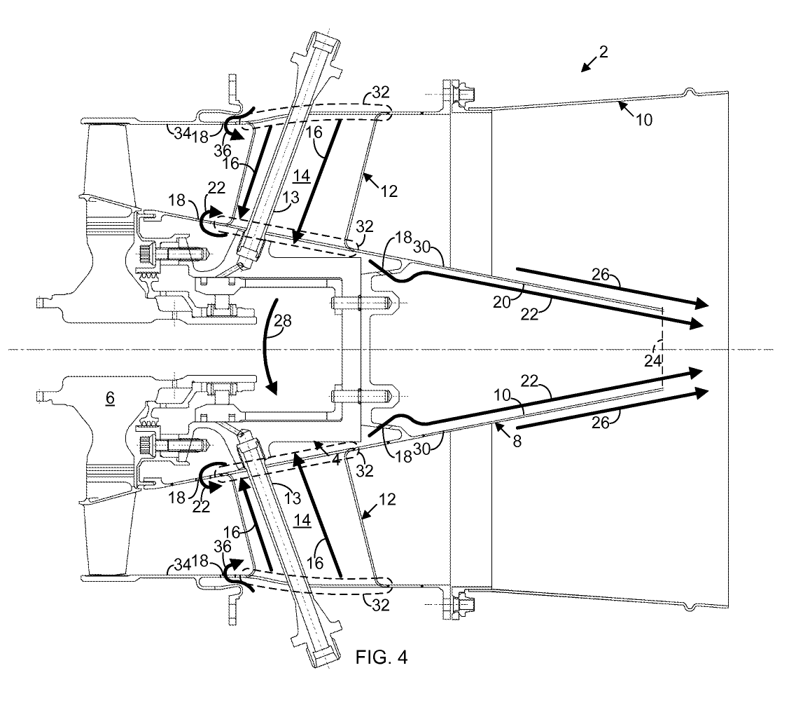

FIG. 1 is a partial cut-away side view of a gas turbine engine that incorporates a cooling system for a rear bearing capsule of a turbine in the gas turbine engine according to a possible embodiment. FIG. 2 is a partial cut-away side view of a gas turbine engine that incorporates a cooling system for a rear bearing capsule of a turbine in the gas turbine engine according to another possible embodiment. FIG. 3 is a partial cut-away side view of a gas turbine engine that incorporates a cooling system for a rear bearing capsule of a turbine in the gas turbine engine according to a third embodiment. FIG. 4 is a partial cut-away side view of a gas turbine engine that incorporates a cooling system for a rear bearing capsule of a turbine in the gas turbine engine according to a fourth embodiment.

FIG. 1 is a partial cut-away side view of a gas turbine engine 2 that incorporates a cooling system for a rear bearing capsule 4 of a turbine 6 in the gas turbine engine 2 according to a first possible embodiment. Referring to FIG. 1, an exhaust cone 8 supports the rear bearing capsule 4 within an exhaust housing 10 of the gas turbine engine 2 by means of multiple exit guide vanes 12 that extend radially from the exhaust cone 8 to the exhaust housing 10. Lubrication oil transfer tubes 13 within the exit guide vanes 12 may supply lubrication oil to the rear bearing capsule 4 from a source of lubrication oil for the gas turbine engine 2.

Air passages 14 through each exit guide vane 12 provide corresponding inlet air flow paths 16 between a source of cool ambient air outside the exhaust housing 10 and the rear bearing capsule 4. The inlet air flow paths 16 allow the cool ambient air to impinge upon the rear bearing capsule 4. The inlet air flow paths 16 also cool the lubrication oil within the lubrication oil transfer tubes 13 to reduce the possibility of oil coking due to thermal breakdown of the lubrication oil.

Apertures 18 in the exhaust cone 8 along an inner surface 20 of the exhaust cone 8 create corresponding discharge air flow paths 22 that pass through the apertures 18 and through an end 24 of the exhaust cone 8 that is open. The discharge air flow paths 22 receive air from the inlet air flow paths 16 after the air passes over the rear bearing capsule 4 discharges it into a high velocity gas flow path 26 in the exhaust housing 10. The high velocity gas flow path 26 is at a lower pressure than that of the inlet air flow paths 16 and the discharge air flow paths 22, which creates a relative vacuum that pulls the cool ambient air into the inlet air flow paths 16 onto the rear bearing capsule 4 and then through the discharge air flow paths 22 into the high velocity gas flow path 26. The cooling system thus circulates a continuous stream of cool ambient air over the rear bearing capsule 4 by way of an eductor or jet-pump effect.

The exit guide vanes 12, or the air passages 14 therein, may have a circumferential cant about the exhaust housing 10 to swirl air from the inlet flow paths 16 about the rear bearing capsule 4. Each aperture 18 may have a staggered circumferential relationship about the exhaust cone 8 relative to its corresponding one of the exit guide vanes 12. The cant of the exit guide vanes 12, or the air passages 14 therein, combined with the position of the apertures 18 relative to the exit guide vanes 12, cause air from the inlet air flow paths 16 to swirl about the rear bearing capsule 4 before reaching the discharge air flow paths 22, as represented by a swirl air flow path 28.

FIG. 2 is a partial cut-away side view of the gas turbine engine 2 that incorporates a cooling system for the rear bearing capsule 4 of the turbine 6 in the gas turbine engine 2 according to a second possible embodiment. Referring to FIG. 2, it is similar to the first embodiment as described in connection with FIG. 1, but in this embodiment the multiple apertures 18 pass through the exhaust cone 8 from its inner surface 20 to an outer surface 30 of the exhaust cone 8 to direct the multiple discharge air flow paths 22 into the high velocity gas flow path 26 along the outer surface 30 of the exhaust cone 8. Since the discharge air flow paths 22 flow along the outer surface 30 of the exhaust cone 8 in this embodiment, it is possible for the end 24 of the exhaust cone 8 to be open or to be closed, as represented by 24′.

This embodiment may also have the exit guide vanes 12, or the air passages 14 therein, about the exhaust housing 10 to swirl air from the inlet flow paths 16 about the rear bearing capsule 4. This embodiment may also have a staggered circumferential relationship for each aperture 18 about the exhaust cone 8 relative to its corresponding one of the exit guide vanes 12 to cause air from the inlet air flow paths 16 to swirl about the rear bearing capsule 4 before reaching the discharge air flow paths 22, as represented by the swirl air flow path 28.

FIG. 3 is a partial cut-away side view of the gas turbine engine 2 that incorporates a cooling system for the rear bearing capsule 4 of the turbine 6 in the gas turbine engine 2 according to a third possible embodiment. This embodiment combines the apertures 18 of the first and second embodiments to include the discharge air flow paths 22 that flow along the inner surface 20 of the exhaust cone 8 as well as along the outer surface 30 of the exhaust cone 8. This arrangement may result in greater cooling effect due to increased air flow through the additional discharge air flow paths 22 and surface area contact with the exhaust cone 8 along both its inner surface 20 and its outer surface 30. In other words, the exhaust cone 8 may serve as an effective heat sink for the rear bearing capsule 4.

FIG. 4 is a partial cut-away side view of the gas turbine engine 2 that incorporates a cooling system for the rear bearing capsule 4 of the turbine 6 in the gas turbine engine according to a fourth possible embodiment. It is desirable to cool filleted regions 32 where the exit guide vanes 12 couple to the exhaust cone 8 and the exhaust housing 10. These filleted regions 32 exhibit the highest stress due to stress concentration, and therefore they are often responsible for failure of the gas turbine engine 2 in service due to cracks. Cooling the filleted regions 32 keeps the filleted regions stronger and less susceptible to cracking. This embodiment cools the filleted regions 32 between the exit guide vanes 12 and the exhaust cone 8 with additional apertures 18 in the exhaust cone 8 that pass through the exhaust cone 8 from its inner surface 20 to its outer surface 30 upstream from the exit guide vanes 12. These additional apertures 18 direct additional multiple discharge air flow paths 22 into the high velocity gas flow path 26 along the outer surface 30 of the exhaust cone 8 to impinge upon the filleted regions 32 between the exit guide vanes 12 and the exhaust cone 8.

This embodiment may also cool the filleted regions 32 between the exit guide vanes 12 and the exhaust housing 10 with additional apertures 18 that penetrate the exhaust housing 10 to an outer surface 34 of the exhaust housing 10 upstream of the exit guide vanes 12. These additional apertures 18 direct additional multiple discharge air flow paths 36 of cool ambient air from the source of cool ambient air outside the exhaust housing 10 into the high velocity gas flow path 26 along the outer surface 34 of the exhaust housing 10 to impinge upon the filleted regions 32 between the exit guide vanes 12 and the exhaust housing 10.

The described embodiments as set forth herein represents only some illustrative implementations of the invention as set forth in the attached claims. Changes and substitutions of various details and arrangement thereof are within the scope of the claimed invention.

1. A cooling system for a rear bearing capsule of a turbine in a gas turbine engine supported by an exhaust cone attached to multiple exit guide vanes that extend radially from the exhaust cone to an exhaust housing, comprising:
an inlet air flow path through each exit guide vane between a source of cool ambient air and the rear bearing capsule; and
at least one discharge air flow path that receives air from the inlet air flow path through each exit guide vane and passes the air through the exhaust cone from the rear bearing capsule to a high velocity gas flow path in the exhaust housing.

2. The cooling system of claim 1, wherein the exhaust cone has an open end and the at least one discharge air flow path passes through the open end of the exhaust cone.

3. The cooling system of claim 2, wherein the at least one discharge air flow path passes through at least one aperture within the exhaust cone along an inner surface of the exhaust cone.

4. The cooling system of claim 3, wherein multiple apertures within the exhaust cone create multiple discharge air flow paths along the inner surface of the exhaust cone.

5. The cooling system of claim 1, wherein the at least one discharge air flow path passes through an inner surface of the exhaust cone to an outer surface of the exhaust cone.

6. The cooling system of claim 5, wherein multiple apertures that penetrate the exhaust cone from the inner surface of the exhaust cone to the outer surface of the exhaust cone create multiple discharge air flow paths along the outer surface of the exhaust cone.

7. The cooling system of claim 6, wherein the exhaust cone has a closed end.

8. The cooling system of claim 6, wherein the exhaust cone has an open end and the at least one discharge air flow path further comprises at least one discharge air flow path that passes through the open end.

9. The cooling system of claim 1, wherein the exit guide vanes cant circumferentially about the exhaust housing to swirl air from the inlet air flow path through each exit guide vane about the rear bearing capsule.

10. The cooling system of claim 9, wherein multiple apertures within the exhaust cone create multiple discharge air flow paths along the inner surface of the exhaust cone, with each aperture staggered circumferentially about the exhaust cone relative to a corresponding one of the exit guide vanes to receive air from the inlet air flow path from its corresponding one of the exit guide vanes.

11. The cooling system of claim 10, wherein the cant of the exit guide vanes and the position of the apertures cause air from the inlet air flow paths that impinge on the rear bearing capsule to swirl about the rear bearing capsule.

12. The cooling system of claim 9, wherein multiple apertures that penetrate the exhaust cone from the inner surface of the exhaust cone to the outer surface of the exhaust cone create multiple discharge air flow paths along the outer surface of the exhaust cone, with each aperture staggered circumferentially about the exhaust cone to receive air from the inlet air flow path through a corresponding one of the exit guide vanes.

13. The cooling system of claim 12, wherein the exhaust cone has an open end and further comprising multiple apertures within the exhaust cone that create multiple discharge air flow paths along the inner surface of the exhaust cone.

14. The cooling system of claim 1, wherein at least one discharge air flow path that receives air from the inlet air flow path through each exit guide vane and passes the air through the exhaust cone from the rear bearing capsule to the high velocity gas flow path in the exhaust housing passes the air upstream from a corresponding one of the exit guide vanes to impinge upon the corresponding exit guide vane.

15. The cooling system of claim 14, further comprising at least one discharge air flow path that receives air from the source of cool ambient air and passes the air through the exhaust housing into the high velocity gas flow path in the exhaust housing upstream from a corresponding one of the exit guide vanes to impinge upon the corresponding exit guide vane.

16. The cooling system of claim 1, further comprising at least one discharge air flow path that receives air from the source of cool ambient air and passes the air through the exhaust housing into the high velocity gas flow path in the exhaust housing upstream from a corresponding one of the exit guide vanes to impinge upon the corresponding exit guide vane.

17. The cooling system of claim 1, wherein the inlet air flow paths cool lubrication oil transfer tubes within the exit guide vanes that supply lubrication oil to the rear bearing capsule.

18. A cooling system for a rear bearing capsule of a turbine in a gas turbine engine supported by an exhaust cone with an open end, the exhaust cone attached to multiple exit guide vanes that extend radially from the exhaust cone to an exhaust housing, comprising:
circumferentially canted air passages within each exit guide vane that create a corresponding inlet air flow path through each exit guide vane between a source of cool ambient air and the rear bearing capsule that impinges on the rear bearing capsule; and
multiple apertures in the exhaust cone that create corresponding discharge air flow path through each aperture that receives air from the inlet air flow path through each exit guide vane and passes the air through the exhaust cone from the rear bearing capsule to a high velocity gas flow path in the exhaust housing.

19. The cooling system of claim 18, wherein the multiple apertures are within the exhaust cone to direct the multiple discharge air flow paths along the inner surface of the exhaust cone.

20. The cooling system of claim 18, wherein the multiple apertures penetrate the exhaust cone from the inner surface of the exhaust cone to the outer surface of the exhaust cone to direct the multiple discharge air flow paths along the outer surface of the exhaust cone.

21. The cooling system of claim 20, wherein the exhaust cone has a closed end.

22. The cooling system of claim 20, wherein the exhaust cone has an open end and further comprising multiple apertures within the exhaust cone to direct the multiple discharge air flow paths along the inner surface of the exhaust cone.

23. The cooling system of claim 18, wherein each aperture has a staggered circumferential relationship about the exhaust cone relative to a corresponding one of the exit guide vanes to receive air from the inlet air flow path of its corresponding one of the exit guide vanes.

24. The cooling system of claim 18, wherein the cant of the exit guide vanes and the position of the apertures cause air from the inlet air flow paths that impinge on the rear bearing capsule to swirl about the rear bearing capsule.

25. The cooling system of claim 18, wherein at least one discharge air flow path that receives air from the inlet air flow path through each exit guide vane and passes the air through the exhaust cone from the rear bearing capsule to the high velocity gas flow path in the exhaust housing passes the air upstream from a corresponding one of the exit guide vanes to impinge upon the corresponding exit guide vane.

26. The cooling system of claim 25, further comprising at least one discharge air flow path that receives air from the source of cool ambient air and passes the air through the exhaust housing into the high velocity gas flow path in the exhaust housing upstream from a corresponding one of the exit guide vanes to impinge upon the corresponding exit guide vane.

27. The cooling system of claim 18, further comprising at least one discharge air flow path that receives air from the source of cool ambient air and passes the air through the exhaust housing into the high velocity gas flow path in the exhaust housing upstream from a corresponding one of the exit guide vanes to impinge upon the corresponding exit guide vane.

28. The cooling system of claim 18, wherein the inlet air flow paths cool lubrication oil transfer tubes within the exit guide vanes that supply lubrication oil to the rear bearing capsule.
